(19) United States
(12) Patent Application Publication
(10) Pub. No.: US 2010/0306030 A1
(43) Pub. Date: Dec. 2, 2010

(54) Contextual Content Targeting

(75) Inventor: Aleem R. Mawani, Markham (CA)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/552,527

(22) Filed: Sep. 2, 2009

Related U.S. Application Data
(60) Provisional application No. 61/182,191, filed on May 29, 2009.

(51) Int. Cl. G06Q 30/00; G06Q 90/00; G06Q 10/00

(52) U.S. Cl. 705/10; 705/500

(57) ABSTRACT

A first item and a second item placed with content in a first medium are identified, and first performance information associated with the placement of the first item in the first medium and second performance information associated with the placement of the second item in the first medium are received. The first performance information is compared to the second performance information, and using at least one processor and based on the comparison of the first performance information to the second performance information, one of the first item or the second item is selected for placement with the same content in a second medium, the second medium being different from the first medium. The selected one of the first item and the second item then is forwarded.

### CROSS REFERENCE TO RELATED APPLICATION

This application claims priority to U.S. Provisional Application No. 61/182,191, which was filed on May 29, 2009, is titled “CONTEXTUAL CONTENT TARGETING,” and is incorporated by reference in its entirety.

### TECHNICAL FIELD

The following disclosure relates to placing content of an appropriate type in media.

### BACKGROUND

Content of different types may be placed in media. For example, advertisers provide advertisements (“ads”) in different forms in order to attract consumers. Types of ads include online ads that can be provided as banner advertisements on a web page, or an ad in a web page that can be presented, for example, in response to one or more keywords in a user search query input to a search engine. If a user selects the presented ad, the user is generally taken to another location associated with the ad, such as, for example, to an associated web page.

Offline electronic ads (e.g., commercials) can be provided with content in, for example, compact disks, electronic publications, and electronic billboards (e.g., in elevators, airports, and along roadways). Advertisers can submit a print ad to a publisher for inclusion in one or more printed publications, such as newspapers or magazines, for a price specified by the publisher. The advertisers typically also specify the placement of the print ad in the printed publication, including parameters such as the edition in which the print ad is to appear, the page on which the print ad is to run, and the size of the print ad.

### SUMMARY

In one general aspect, a first item and a second item placed with content in a first medium are identified, and first performance information associated with the placement of the first item in the first medium and second performance information associated with the placement of the second item in the first medium are received. The first performance information is compared to the second performance information, and using at least one processor and based on the comparison of the first performance information to the second performance information, one of the first item or the second item is selected for placement with the same content in a second medium, the second medium being different from the first medium. The selected one of the first item and the second item then is forwarded.

Implementations may include one or more of the following features. For example, the first item may be a first advertisement and the second item may be a second advertisement that is different from the first advertisement. The first medium may be online and the second medium may be print.

Identifying the first item and the second item placed with the content in the first medium may include identifying the first item and the second item as being placed on a web page including the content at the same time, or at different times.

Receiving the first and second performance information associated with the placement of the first item and the second item in the first medium may include receiving a number of times the first item was selected in the first medium and a number of times the second item was selected in the first medium. Comparing the first performance information to the second performance information may include determining that the number of times the first item was selected in the first medium is greater than the number of times the second item was selected in the first medium, and selecting one of the first item and the second item for placement with the same content in the second medium may include selecting, based on the determination that the number of times the first item was selected in the first medium is greater than the number of times the second item was selected in the first medium, the first item for placement with the same content in the second medium.

In other implementations, a determination may be made that the first performance information associated with the placement of the first item in the first medium satisfies a threshold. When such a determination is made, selecting one of the first item and the second item for placement with the same content in the second medium may include selecting, based on the determination that the first performance information associated with the placement of the first item in the first medium satisfies a threshold, the first item for placement with the same content in the second medium. For example, receiving the first performance information associated with the placement of the first item in the first medium may include receiving a ratio of a number of times the first item was selected to a number of times the first item was placed in the first medium, and determining that the first performance information associated with the placement of the first item in the first medium satisfies the threshold may include determining that the ratio of the number of times the first item was selected to the number of times the first item was placed in the first medium is greater than a predetermined threshold.

Identifying the first item and the second item placed with the content in the first medium may include determining that the first item and the second item are related to the content. Determining that the first item and the second item are related to the content also may include determining a context of the content and determining that a context of the first item and a context of the second item are the same as the context of the content.

Requirements for placement of items with the content in the first medium may be received, and identifying the first item and the second item placed with the content in the first medium may include determining that the first item and the second item satisfy the received requirements for placement of items with the content in the first medium.

Details of one or more implementations are set forth in the accompanying drawings and the description below. Other aspects can be implemented in systems and computers and will be apparent from the description and drawings, and from the claims.

### DESCRIPTION OF DRAWINGS

FIG. 1 is a flowchart showing an example process for identifying and forwarding an item.

FIG. 2 is a block diagram showing placement requirements.

FIG. 3 is a block diagram showing item requirements.

FIG. 4 is a flowchart showing an example process for forwarding an item in two different types of media.

FIG. 5 shows an example of a print ad.

FIG. 6 is a block diagram of an example electronic advertisement system.

FIG. 7 shows a schematic diagram of an example computer system.

Like reference symbols indicate like elements throughout the specification and drawings.

### DETAILED DESCRIPTION

Techniques, methods, apparatus, computer program products, and systems for content presentation (e.g., advertising) are described that can be used to facilitate publication. Reference will be made herein to publication of ads, though publication of other forms of content items are possible. Print advertising as used herein refers to advertising occurring in print media, such as newspapers, magazines, journals, periodicals, flyers, brochures, and other printed publications. An ad placed in a printed publication shall be referred to herein as a “print ad.” While the discussion below makes reference to print ads for ease of illustration, the systems and methods disclosed herein can be applied to other forms of sponsored content, such as online ads, radio ads, and television ads.

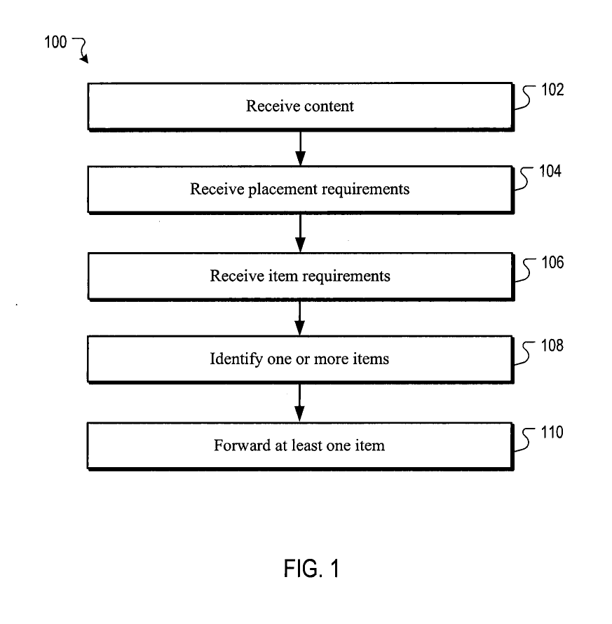

FIG. 1 is a flowchart showing an example process 100 for identifying and forwarding an item, such as an advertisement. One or more steps in the process 100 can be carried out by, for example, an electronic system (e.g., an electronic advertisement system).

The electronic advertisement system initially receives content that will be published in a first medium, such as, for example, print (step 102). The content can be received automatically by the system (e.g., without human intervention) so that the security and/or confidentiality of the content is assured. The content can include various types of information, such as articles, discussion threads, reports, analyses, financial statements, graphics, search results, web page listings, and printed publications. The content can be received from the creator of the content. For example, if the content is an article, the content can be received from a news reporting organization. The content can also be received from an entity that will publish the content, but may or may not have created the content. For example, if the content is an article, the article can be received from a publisher that will publish the article.

The complete content can be received by the system. For example, if the content is an article, the system can receive an electronic file including the content. In addition, an identifier of the content can be received by the system. For example, a numerical identifier of an article written by a news reporting organization can be received by the system. The system can then use the identifier to retrieve the content from the news reporting organization. A link to a web page that includes the content can also be received by the system. The system can then use the link to access the content on the web page.

The content can be received by the system at any time before the content is published. For example, the content can be received at least a predetermined time, such as, for example, six hours, before the content is published. Therefore, the layout of the publication, including the location of the content and the location of any ads surrounding the content, can be specified when the content is received by the system. In another example, the content can be received by the system within a predetermined time after the content has been prepared. For example, an article can be received within 15 minutes after an editor approves the article for publication.

In some implementations, the electronic advertisement system can receive additional information associated with the content. For example, the system can receive one or more of a summary of the content (e.g., an abstract of an article), a title of the content, authors of the content, a date that the content was created, an identifier of the organization that created the content, a word count of the content, an identifier of one or more publications that will publish the content, an identifier of a publisher of the content, date(s) that the content will be published in the one or more publications, a page number on which the content will be published, a section of the one or more publications in which the content will be published, an indication of whether the content will be published in color or black and white, and an indication of whether the content will be published on a left hand page or a right hand page of the publication.

The system can also receive additional information about the one or more publications that will publish the content. For example, the information about the one or more publications can include one or more of a circulation of a publication, a geographic distribution region of a publication, demographic characteristics of the readers of the publication, and an industry category or “vertical” associated with a publication.

The system can receive some or all of the additional information at the same time the system receives the content. Additionally, the system can receive some or all of the additional information from a database accessible to the system before and/or after receiving the content. For example, the database can be stored on a storage device of the system or on a third-party server.

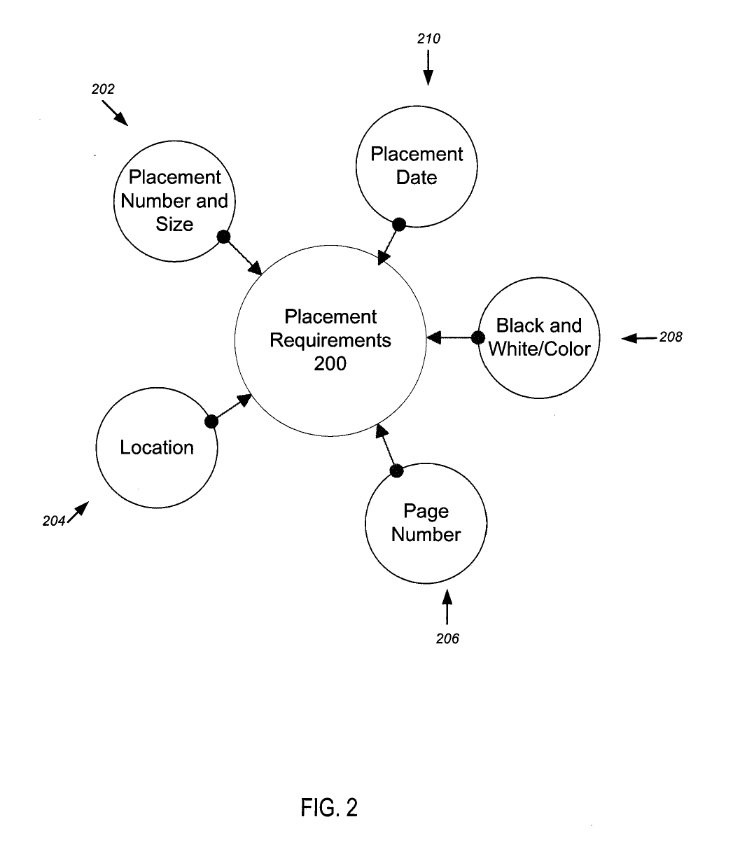

With reference also to FIG. 2, the electronic advertisement system also receives placement requirements 200 (step 104). The placement requirements 200 can be included in an item placement request that is received from the entity that will publish the content (e.g., publisher) with the content. The item placement request can also be received from an advertiser and/or from a third party, such as, for example, an advertising agency. The publisher can submit the request to the system using, for example, a graphical user interface (“GUI”). In some implementations, the request can be generated by the system. For example, the system can generate the request based on an ad campaign for the publication in which the print ad will be placed.

The placement requirements 200 can include one or more of the requirements including a number and size of the space (i.e., slots) in which the items are to be placed 202, a location of the placement 204, a page number of the placement 206, a placement color identifier 208, and a date of placement 210, as described in greater detail below in connection with FIG. 2.

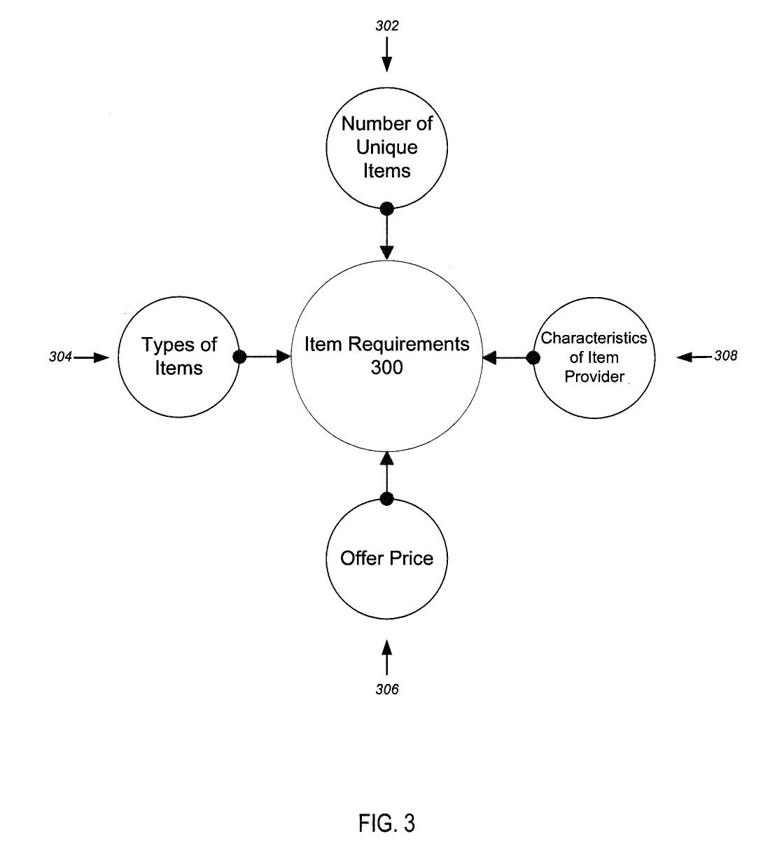

With reference also to FIG. 3, the electronic advertisement system also receives item requirements 300 (step 106). The item requirements 300 can be included in the item placement request, or can be separately received by the system. The item requirements can include one or more of the requirements including a maximum number of unique items to be placed 302, a type of item to be placed 304, an offer price for the item to be placed 306, and characteristics of the item provider (e.g., an advertiser) 308, as described in greater detail below in connection with FIG. 3.

The electronic advertisement system then identifies one or more items based on the content, the placement requirements 200, and/or the item requirements 300 (step 108). Ads can be identified from among ads stored in one or more databases. In addition to the ads themselves, the one or more databases can store statistical information about which ads have been placed in media, how often the ads have been placed, the number of times the ads have been selected, who has selected the ads, and how often the placement of an ad has led to consummation of a transaction.

The one or more databases can be stored on a storage device of the system or on a storage device of another system that is accessible to the system. In some implementations, the system can initially group the stored ads that satisfy some or all of the placement requirements 200 and/or item requirements 300. The system will then identify those grouped ads that are contextually relevant to the content. In other implementations, the system can initially group the stored ads that are contextually relevant to the content, and then identify those grouped ads that satisfy some or all of the placement requirements 200 and/or item requirements 300. In yet other implementations, the system can group the stored ads that are contextually relevant in parallel with grouping the stored ads that satisfy some or all of the placement requirements 200 and/or item requirements 300. The system will them identify ads that are present in both groups for placement in an available slot.

The system obtains information about a “context” or “classification” of the content, such as, for example, the subject of the content. The context of the content can be identified based on words included in the content. If, for example, the content is an article about cholesterol prevention, the context of the content can be “cholesterol” and/or “cholesterol prevention.” In another example, the content can be searched for predetermined keywords to identify the context of the content. For example, “health” and “heart” can be two predetermined keywords included in the content. In response, the context of the content can include “health” and/or “heart.”

The system then uses the context of the content to identify items (e.g., print ads) associated with the context. For example, if the context is determined to be “cholesterol prevention,” one or more ads associated with “cholesterol prevention” can be identified by the system. In some implementations, contextually relevant ads can be assigned scores based on their contextual similarity to the content. For example, if the context of the content is “cholesterol prevention,” an ad associated with “cholesterol prevention” can be assigned a higher score than an ad for “heart attack prevention,” although both are contextually relevant.

In addition to the context of the content, the system can use the section of a publication in which the content will be published to identify print ads. For example, an article regarding the possibility of a salary cap in baseball can include the context of “baseball” and “books.” If the article is being published in a sports section of a newspaper, the system can identify ads related to baseball. If, however, the article is being published in the business section of the newspaper, the system can identify ads related to books.

Similarly, the system can use the demographics of the publication in which the content will be published to identify print ads. For example, if a young male is the typical reader of a magazine that publishes the article regarding the possibility of a salary cap in baseball, the system can identify ads related to baseball. If, however, the article was being published by a magazine with an older reader demographic, the system can identify ads related to books.

If a contextually relevant ad was previously placed online, performance information, such as the click-through rate of the ad in other online content having a similar context, stored in the one or more databases can be used as a basis for additional scoring of the ad and/or modifying the scores of the ad. For example, if two contextually relevant ads are identified, the score of the ad with the higher click-through rate online can be higher than the score of the other ad.

The characteristics of the ads can be compared with the placement requirements 200 to identify ads that satisfy the placement requirements 200. For example, if an ad expires before the publication date of the ad, the ad is not identified. In some implementations, ads can be assigned additional scores, and/or scores previously assigned to the ads can be modified, based on the comparison of the ads' characteristics to the placement requirements 200.

For example, if a machine learning algorithm of the system determines that the response to text ads is greater than image ads if the ad is placed within the content (e.g., halfway through an article), higher scores can be assigned to text ads than image ads if the location requirement 204 indicates that the slot is within the content. Similarly, if the page number of the placement 206 indicates that the ad will be placed on a left hand page, the machine learning algorithm can identify the ads that are more likely to generate a greater response on a left hand page based on, for example, the layout of the ads. As a result, higher scores can be assigned to those ads that are more likely to generate a greater response.

In addition, the characteristics of the ads can be compared to the item requirements 300 to identify ads that satisfy the item requirements 300. For example, if the type of item 304 specifies that only text ads can be placed in a particular slot, ads including images are not identified. Similarly, if the characteristics of item provider requirements 308 specify that only ads for advertisers having a physical presence in New York City be placed in a slot, ads for advertisers outside of New York City are not identified.

In some implementations, ads can be assigned additional scores, and/or scores previously assigned to the ads can be modified, based on the comparison of the ad characteristics to the item requirements 300. For example, ads associated with a higher offer price can be assigned higher scores. In another example, the greater the correlation between the characteristics of an advertiser to the characteristics of item provider requirement 308, the higher the score assigned to ads associated with the advertiser.

If more than one ad is identified for a particular slot, the identified ads can be ranked according to scores assigned to the ads. If an ad includes more than one score, the scores of an ad can be combined using, for example, a weighted-sum algorithm. In some implementations where the contextual relevancy of only ads that satisfy the placement requirements 200 and/or item requirements 300 is determined, only the contextual relevancy score is used to rank the ads.

If a contextually relevant ad does not satisfy the placement requirements 200 and/or item requirements 300, the system can modify the contextually relevant ad to satisfy the requirements. For example, if the ad is slightly (e.g., 5 percent) larger than the size of the slot defined in the size requirement 202, the ad can be resized by the system to the defined slot size. In another example, if the requirement 208 indicates that a black and white ad is to be placed in a slot and the contextually relevant ad is in color, the system can convert the ad into black and white.

The system then electronically forwards at least one item to be placed (step 110). For example, the system can forward a predetermined number of the highest ranking items to a content provider, such as a publisher, for placement in media, such as a publication. The system also can forward the at least one item to a third party, such as an advertising agency, who can then forward the print ad to the content provider for placement in media. The number of items to be forwarded can be determined based on the number of slots available and/or the number of unique items 302 included in the item requirements 300.

If more than one ad is identified for a slot, the system can bundle the ads together. For example, multiple text print ads can be combined into a single ad for placement within the slot. An identifier of the one slot associated with the ad can also be forwarded by the system so that the publisher matches the ad to the appropriate slot.

In some implementations, the advertiser can provide the ads that are stored in the one or more databases. In some implementations, the system can create the ads. For example, the system can access existing online information such as contact information, geographic information, image information, product information, user review information, and/or auction information to create the print ads. In another example, the advertiser can provide information to the system to include in the ads. In this example, the advertiser can upload an image and/or provide a product description, which the system can use to create the ads.

FIG. 2 is a block diagram showing placement requirements 200 that can be included in an item placement request. Some or all of the requirements 202, 204, 206, 208, 210 can be included in the request.

The number and size of the space (e.g., slot) in which the items are to be placed 202 can include the number and size of each slot in which the ads will be placed within the media. For example, if the media is a publication, the placement size can be defined as a fraction of a page, a number of columns, and/or a unit of measurement, such as inches or centimeters. In another example, if the media is a television and/or radio program, the placement size can be defined as a duration of time, such as 30 seconds. If more than one slot is available for ad placement, the size of each slot can be received. If slots are all the same size, then the number of the available slots can be received along with only one size identification.

The location of the placement 204 can be defined as the spatial and/or temporal location of each slot relative to the media. For example, if the media is a publication, the spatial location of a slot can be defined by the coordinates of the end points of the slot and/or by the distance of the slot from one or more edges of the publication. For example, the coordinates of the bottom-right corner of each slot can be received. In combination with the size of the slot, the area of the slot in the publication can be identified by the system. If the media is a television and/or radio program, the temporal location of a slot can be defined by, for example, a predetermined time period from the start of the program.

The location of the placement 204 can also be defined relative to the content. If the media is a publication, the spatial location of a slot can be a location relative to a spatial location of an article. The slot can be defined to be, for example, to the left and/or above the article. If the slot is within the article, the slot can be defined to be, for example, half-way through the text of the article. Similarly, if the media is a television and/or radio program, the temporal location of the slot can be half-way through the program.

The location of the placement 204 can also be defined relative to other content published in the media. If the media is a publication, the spatial location of a slot can be a location relative to other ad slots and/or articles in the publication. The slot can be, for example, below a first article and above a second article, neither of which are the received content. If the media is a television and/or radio program, the temporal location of the slot can be defined as being between two other ad slots.

A page number of the placement 206 can include one or more page numbers that include slots. If the content and the print ad are placed on different pages, a page number of the slot and a page number of the content can be received by the system. In some implementations, the page number of the placement 206 can identify whether one or more of the page numbers are left hand pages or right hand pages.

The color placement identifier 208 includes indications of whether slots for ad placement will be in black and white or in color. For example, the identification of each slot as being in black and white or in color can be included in the color placement identifier 208. In some implementations, if multiple ad placement slots are included in the same media, such as in the same publication, the multiple ad placement slots can share the same color identifier. In some implementations, if multiple ad placement slots are included on the same page, the multiple ad placement slots can share the same color identifier, but ad placements on different pages of the same media can have different color identifiers.

A date of placement 210 can include one or more dates on which the ad will be placed. For example, if the ad will be placed with the content in a newspaper for one day, the date of placement 210 can include an identifier of a single day. In another example, if the ad will be placed with the content in a monthly magazine, the date of placement 210 can include an identifier of a month. If the ad will be placed with the content in multiple media, such as multiple newspapers, on the same date, then a single date of placement can be associated with the multiple media. If the ad will be placed with the content in multiple media on different dates, then each ad placement slot can be associated with an identifier of a respective date of placement.

FIG. 3 is a block diagram showing item requirements 300 that can be included in an item placement request. Some or all of the requirements 302, 304, 306, 308 can be included in the request.

The number of unique items 302 includes a number of unique (i.e., different) items that can be selected for placement with the content. For example, if more than one ad can fill a single slot, the number of different ads that are placed in the single slot can be limited. In another example, if a page of a newspaper includes multiple slots for ad placement, a maximum number of unique ads can be specified, so that one ad may be repeated on the same page.

The type of item to be placed 304 includes a type of ad to be placed. The type of ad can be selected from predetermined types of ads, such as, for example, text-only ads, image-only ads, and mixed text and image ads. The type of ads can be specified per slot, per page, per publication section, and/or per publication. For example, the publisher can permit only text ads to be placed in an editorial section of a newspaper, while permitting only image ads to be placed in an arts section of the newspaper. In another example, a black and white newsletter can permit only text ads to be placed in available slots, whereas a sports magazine can permit image and/or mixed text and image ads to be placed. In some implementations, slots can be designated as standard or premium slots. For example, a publisher can permit only text ads to be placed in standard slots, while permitting any type of ad to be placed in a premium slot.

The offer price for the item to be placed 306 can include a price per predetermined number of impressions that the item must satisfy. For example, a publisher can designate a minimum cost per thousand impressions (CPM) for each available slot, for all slots on a page, for all slots in a section, and/or for each publication. In some implementations, standard slots can have a first minimum CPM and premium slots can have a second, higher minimum CPM.

The characteristics of the item provider (e.g., an advertiser) 308 can include demographic requirements of an advertiser associated with an item to be placed in a slot. For example, a publisher may require that an advertiser generate a minimum and/or maximum amount of revenue, have a minimum and/or maximum number of employees, and/or have a minimum and/or maximum number of locations. In addition, the publisher can require that an advertiser be local to a particular geographic area, such as the geographic distribution area of the publication in which the ad will be placed, or be national. The publisher can also require that an advertiser have a physical presence and/or distribute its products in a particular geographic region, such as the geographic distribution area of the publication in which the ad will be placed. For example, if a magazine is distributed only in New York City, a publisher can permit only ads for advertisers having a physical presence in New York City to be identified. In some implementations, the identifier of the particular geographic region can be an identifier of a neighborhood, an identifier of a city, an identifier of a county, an identifier of a metropolitan area, an identifier of a state, an identifier of a region of a country, an identifier of a country, and/or an identifier of a region in the world.

The publisher can also specify the industry category or “vertical” of an advertiser. For example, the publisher can require that the advertiser be an automobile manufacturer. The industry category can be specified for each available slot, for all slots on a page, for all slots in a section, and/or for each publication. For example, a publisher can require that all slots in a business section be filled by ads for banks. In some implementations, the publisher can also exclude advertisers based on industry category or “vertical” of the advertisers. For example, a children's publication can exclude ads for tobacco manufacturers.

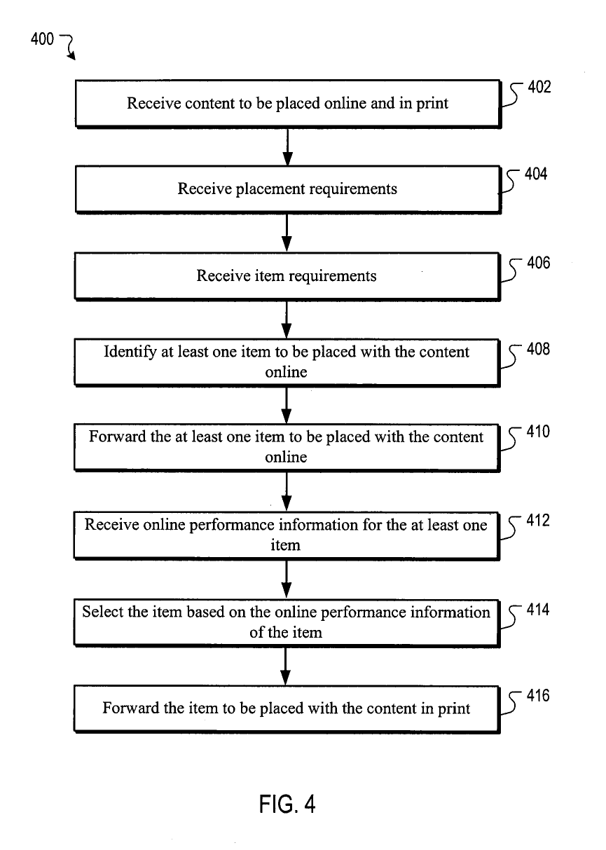

FIG. 4 is a flowchart showing an example process 400 for forwarding an item in two different types of media. One or more steps in the process 400 can be carried out by, for example, an electronic system (e.g., an electronic advertisement system).

The electronic advertisement system initially receives content that will be published in two media, such as, for example, online and in print (step 402). The techniques for receiving the content are similar to those described above in connection with step 102. However, whereas the content received in step 102 was to be placed in at least one medium, the content received in step 402 will be placed in at least two media at different times. For example, the content can be placed online before it is placed in print.

The content can be, for example, an article that is placed on a web page of a news organization and that is syndicated in, for example, a newspaper. In some implementations, the content can be received at the system before the content is placed in either medium. In other implementations, the content can be received after the content has been placed in the first medium (e.g., online), but before the content is placed in the second medium (e.g., print).

The system can also receive placement restrictions 200 (step 404) and item restrictions 300 (step 406), as described above in connection with steps 104 and 106, respectively. The placement restrictions can include restrictions for only one medium (e.g., print), or include placement and item restrictions for two or more media. The placement and item restrictions for the different media can be the same or different. In implementations where the content is received after it is placed in the first medium, the placement restrictions 200 and item restrictions 300 can include restrictions for only the second medium.

In some implementations, the item restrictions 300 can also include a minimum online performance restriction that an ad must satisfy to be placed in the second medium. For example, if the online performance information is a click-through rate, as described in greater detail below, the item restrictions 300 can require that the click-through rate be higher than, for example, five percent.

In some implementations, the system then identifies at least one item to be placed with the content in the first medium (e.g., online) (step 408). For example, in implementations where the content is received before the content is placed in either medium, the system can identify ads to be placed with the content online. As similarly described above in connection with step 108, the context of the content can be determined and used to identify the at least one online ad. In one example, a predetermined number of the highest ranked ads can be identified. In another example, ads having a score higher than a predetermined threshold can be identified.

The system electronically forwards the at least one ad to be placed with the content online (step 410). As similarly described above in connection with step 110, the system can receive the ad from an advertiser and/or the system can generate the ad. In some implementations, the system can also modify the ad to satisfy received online placement requirements 200 and online item requirements 300.

After the at least one item has been placed online, the system receives online performance information for the at least one item (step 412). The online performance information can be continually received while the ad is placed online, can be received after a statistically significant amount of online performance information has been collected, and/or can be received a predetermined amount of time after the ad has been placed online.

This online performance information can be used to determine whether an ad should be placed in a printed publication in association with the content based on how the ad performs online with a desired demographic for the publication in association with the same content. For example, if an article about a particular issue is to be published online as well as in print publications, how well different ads perform in conjunction with that specific article online can be used as a determining factor in whether the ads will perform well if placed in a print publication spatially near that same article.

The online performance information can include the click-through rate of each ad placed with the content. A “click-through” can occur, for example, when a user clicks or otherwise selects the ad placed with the content. A click-through rate can represent the number of selections (e.g., clicks) for a given number of impressions. The click-through rate can be determined, for example, by dividing the number of selections of the ad by the number of times the ad was placed. For example, if an ad is placed 250 times and it was selected (e.g., clicked on) 5 times, the click-through rate would be 2 percent.

The online performance information can also include a conversion rate of each ad placed with the content. A “conversion” can occur when a user consummates a transaction related to a given ad. A conversion can also be defined to occur when a user consummates a purchase before leaving the advertiser's web page. In another example, a conversion can be defined as a purchase on the advertiser's web page within a predetermined time (e.g., seven days) after the user selects an ad. In yet another example, a conversion can be defined to be any measurable/observable user action such as, for example, downloading a white paper, navigating to at least a given depth of a Website, viewing at least a certain number of web pages, spending at least a predetermined amount of time on a web page, registering on a web page, dialing a telephone number, sending a product and/or service inquiry. The “conversion rate” can be defined as the ratio of the number of conversions to the number of impressions of the ad, and/or the ratio of the number of conversions to the number of selections of the ad.

Demographic and geographic information associated with the selections and/or conversions of each online ad can also be included in the online performance information. For example, geographic information of users that selected the online ads can be obtained using standard techniques, such as by accessing GPS information associated with a user device, or based on an IP address from which the selection and/or conversion originated. The format of the geographic information may take a variety of forms, including full addresses, city and state names, zip codes, metropolitan areas, and latitude/longitude pairs.

In addition, the demographic information of users that selected the online ads can be received from user profiles accessible to the user. The user profiles can, for example, include general demographic data about a user, such as age, sex, location, and/or interests. The user profile can also include professional information, such as occupation and/or educational background.

In some implementations, the user profiles for all users that selected and/or converted an online ad can be aggregated to create average demographic information associated with the online ad. For example, the system can determine that 20 year old males from California are most likely to select a first particular online ad, whereas females over 40 years old nationwide are most likely to select a second particular online ad. Using the demographic information, the online performance of the online ads can be analyzed by any of the demographic and/or geographic information (e.g., by age or particular location).

The system then selects an ad based on the received online performance information for placement in a second medium (e.g., print) (step 414). For example, if multiple ads are placed with the content online, the online performance information of each ad is used to identify the best performing ad for placement in the second medium. If the online performance information is the click-through rate, for example, the ad having the highest click-through rate can be identified for placement with the content in print.

In some implementations, scores can be calculated for the ads. The scores can be based on the online performance information. For example, the higher the ad's click-through rate online, the higher the score for the ad. Similarly, the higher the ad's conversion rate, the higher the score for the ad.

The scores can also be based on the contextual similarity of an ad to the content, as described above. As such, the closer the contextual similarity between the ad and the content, the higher the score for the ad. The score can also be based on the similarity between the demographic information of the users that selected and/or converted the ad and the demographic information of the readers of the publication in which the ad will be placed. For example, the score for an ad that is, on average, selected by a 15 year-old will be higher for a publication directed towards teens than a publication directed towards seniors. The score can also be based on the similarity between the geographic locations of the users who selected and/or converted the ad and the geographic distribution region of the publication in which the ad will be placed. For example, the score for an ad that is most frequently selected by users in California will be higher for a publication that is distributed in California than for a publication that is distributed in New York.

In some implementations, the scores based on online performance information, contextual similarity, demographic similarity, and/or geographic similarity can be aggregated into a single score using a weighted-sum algorithm. The algorithm can assign weights to each score to determine the weighted sum. The ads can then be ranked by the system based on the scores for the ads.

In some implementations, a predetermined number of the highest ranking ads can be selected. In other implementations, all ads having a score greater than a predetermined threshold can be selected.

After the system selects at least one print ad to be placed with the content in print, the system forward the print ad (step 416), as similarly described above in connection with step 110. The system can modify the ad to satisfy the placement requirements 200 and the item requirements 300 for print if the requirements for print are different from those online.

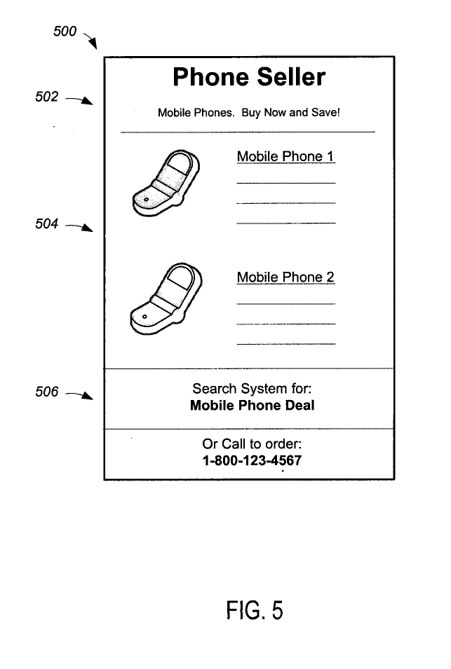

FIG. 5 shows an example of print ad 500 that is forwarded in connection with steps 110 and 416. The print ad 500 includes an advertiser name 502 and product descriptions 504. In implementations where the print ad is created by the system, the advertiser name and product descriptions can be retrieved from the existing online information for the advertiser or from the advertiser itself. One or more response mechanisms 506, such as a search term and/or phone number can be included in the print ad. In some implementations, different response mechanisms can be included in different media. A consumer can choose to use either the search term or telephone number, or both, to learn more about the promotion. Although print ad 500 includes images, in some implementations, a print ad can include only text.

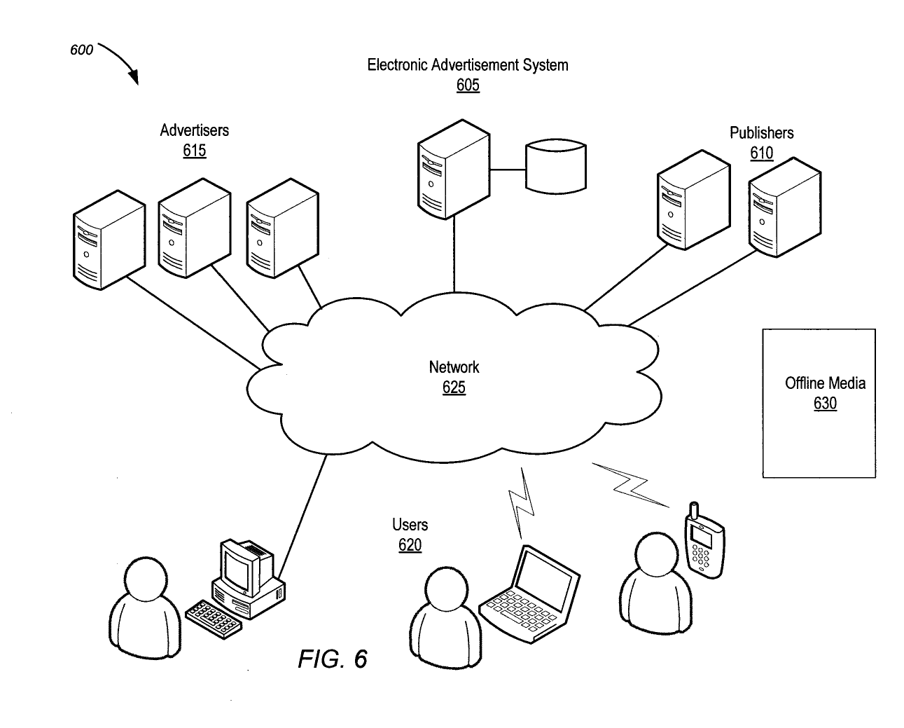

FIG. 6 is a block diagram of an example advertising system 600. The advertising system 600 includes an electronic advertisement system 605, publishers 610, advertisers 615, and users 620. A publisher 610 is an entity that publishes content or places content for publication with another entity. An advertiser 615 is an entity that desires to place a print ad in a printed publication. The advertiser 615 can be a direct supplier (e.g., an advertising entity) or an indirect supplier of the print ad. In some implementations, the advertiser 615 and one or more of the publishers 610 can have a specified relationship, such as a previous advertising relationship.

The system further includes an electronic advertisement system 605. The electronic advertisement system 605 operates to bring the advertisers 615 and publishers 610 together. Each of these entities can be coupled to a network 625 (e.g., the Internet) using one or more communication channels (e.g., wireless, optical, Ethernet). The advertising system 600 also includes offline media 630, such as, for example, print media, television media, and radio media. The advertisements within offline media 630 can be monitored by the electronic advertisement system 605.

The functional operations described can be implemented in digital electronic circuitry, or in computer hardware, firmware, software, or in combinations of them. The electronic advertisement system 605 can be implemented in a computer program product tangibly embodied in a machine-readable storage device for execution by a programmable processor. The steps performed by the electronic advertisement system 605 can be performed by a programmable processor executing a program of instructions to perform functions by operating on input data and generating output.

The electronic advertisement system 605 can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the electronic advertisement system 605 can be implemented on a computer system having a display device such as a monitor or LCD screen for displaying information to the user and a keyboard and a pointing device such as a mouse or a trackball by which the user can provide input to the computer system. The computer system can be programmed to provide a GUI through which computer programs interact with users.

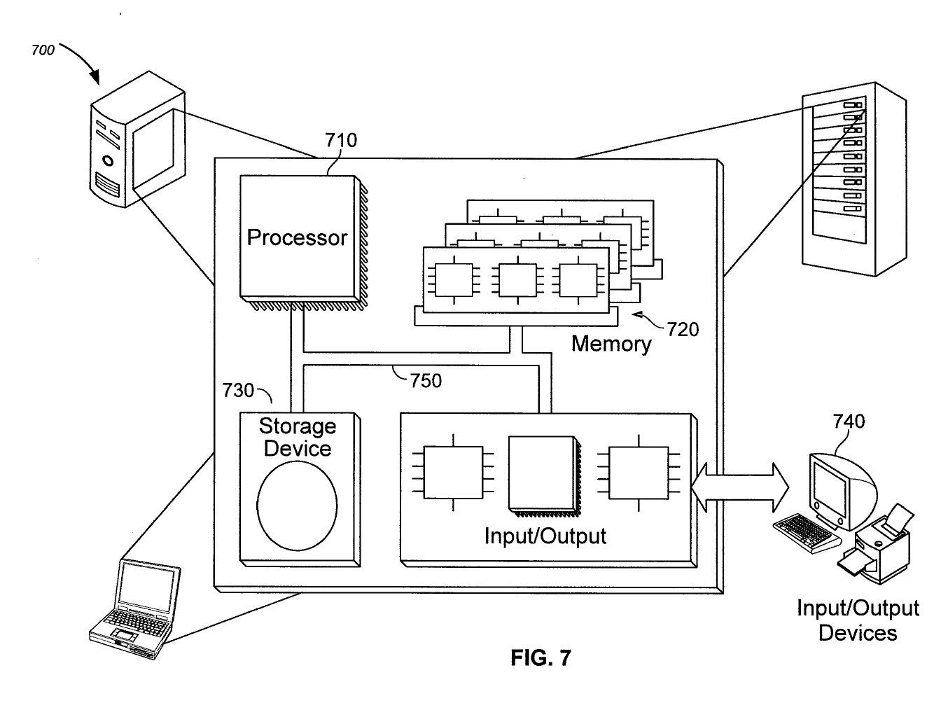

FIG. 7 shows a schematic diagram of an example computer system 700 that can be used to implement a server hosting the electronic advertisement system 605, the advertisers 615, and/or the publishers 610.

The system 700 includes a processor 710, a memory 720, a storage device 730, and an input/output device 740. Each of the components 710, 720, 730, and 740 can, for example, be interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740. In some embodiments, a parallel processing set of systems 700 connected over a network may be employed, clustered into one or more server centers.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 includes a keyboard and/or pointing device. In another implementation, the input/output device 740 includes a display unit for displaying GUIs.

A module can be a piece of hardware that encapsulates a function, can be firmware or can be a software application. A module can perform one or more functions, and one piece of hardware, firmware or software can perform the functions of more than one of the modules described herein. Similarly, more than one piece of hardware, firmware and/or software can be used to perform the function of a single module described herein.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a publisher” includes two or more publishers and reference to “an ad” includes a combination of two or more different types of ads.

A number of implementations have been described. Nevertheless, it will be understood that various modifications may be made without departing from the spirit and scope of the claims.

Accordingly, other implementations are within the scope of this application.

What is claimed is:

1. A method, comprising:
identifying a first item and a second item placed with content in a first medium;
receiving first performance information associated with the placement of the first item in the first medium;
receiving second performance information associated with the placement of the second item in the first medium;
comparing the first performance information to the second performance information;
selecting, using at least one processor and based on the comparison of the first performance information to the second performance information, one of the first item or the second item for placement with the same content in a second medium, the second medium being different from the first medium; and
forwarding, in response to the selection of the selection of one of the first item and the second item, the selected one of the first item and the second item.

2. The method of claim 1, wherein:
the first item is a first advertisement; and
the second item is a second advertisement that is different from the first advertisement.

3. The method of claim 1, wherein the first medium is online and the second medium is print.

4. The method of claim 1, wherein identifying the first item and the second item placed with the content in the first medium comprises identifying the first item and the second item as being placed on a web page including the content at the same time.

5. The method of claim 1, wherein identifying the first item and the second item placed with the content in the first medium comprises identifying the first item and the second item as being placed on a web page including the content at different times.

6. The method of claim 1, wherein:
receiving the first performance information associated with the placement of the first item in the first medium comprises receiving a number of times the first item was selected in the first medium; and
receiving the second performance information associated with the placement of the second item in the first medium comprises receiving a number of times the second item was selected in the first medium.

7. The method of claim 6, wherein:
comparing the first performance information to the second performance information comprises determining that the number of times the first item was selected in the first medium is greater than the number of times the second item was selected in the first medium; and
selecting one of the first item and the second item for placement with the same content in the second medium comprises selecting, based on the determination that the number of times the first item was selected in the first medium is greater than the number of times the second item was selected in the first medium, the first item for placement with the same content in the second medium.

8. The method of claim 1, further comprising determining that the first performance information associated with the placement of the first item in the first medium satisfies a threshold, wherein selecting one of the first item and the second item for placement with the same content in the second medium comprises selecting, based on the determination that the first performance information associated with the placement of the first item in the first medium satisfies a threshold, the first item for placement with the same content in the second medium.

9. The method of claim 8, wherein:
receiving the first performance information associated with the placement of the first item in the first medium comprises receiving a ratio of a number of times the first item was selected to a number of times the first item was placed in the first medium; and
determining that the first performance information associated with the placement of the first item in the first medium satisfies the threshold comprises determining that the ratio of the number of times the first item was selected to the number of times the first item was placed in the first medium is greater than a predetermined threshold.

10. The method of claim 1, wherein identifying the first item and the second item placed with the content in the first medium comprises determining that the first item and the second item are related to the content.

11. The method of claim 10, wherein determining that the first item and the second item are related to the content comprises:
determining a context of the content; and
determining that a context of the first item and a context of the second item are the same as the context of the content.

12. The method of claim 1, further comprising:
receiving requirements for placement of items with the content in the first medium, wherein identifying the first item and the second item placed with the content in the first medium comprises determining that the first item and the second item satisfy the received requirements for placement of items with the content in the first medium.

13. A system comprising at least one processor connected to at least one storage device, wherein the at least one processor is configured to:
identify a first item and a second item placed with content in a first medium;
receive first performance information associated with the placement of the first item in the first medium;
receive second performance information associated with the placement of the second item in the first medium;
compare the first performance information to the second performance information;
select, based on the comparison of the first performance information to the second performance information, one of the first item or the second item for placement with the same content in a second medium, the second medium being different from the first medium; and
forward, in response to the selection of the selection of one of the first item and the second item, the selected one of the first item and the second item.

14. The system of claim 13, wherein:
the first item is a first advertisement;
the second item is a second advertisement that is different from the first advertisement;
the first medium is online; and
the second medium is print.

15. The system of claim 13, wherein the processor is configured to identify the first item and the second item placed with the content in the first medium by determining that the first item and the second item are related to the content.

16. The system of claim 15, wherein the processor is configured to determine that the first item and the second item are related to the content by:
determining a context of the content; and
determining that a context of the first item and a context of the second item are the same as the context of the content.

17. A storage device storing a computer program, the computer program comprising one or more code segments that, when executed, cause at least one processor to:
identify a first item and a second item placed with content in a first medium;
receive first performance information associated with the placement of the first item in the first medium;
receive second performance information associated with the placement of the second item in the first medium;
compare the first performance information to the second performance information;
select, based on the comparison of the first performance information to the second performance information, one of the first item or the second item for placement with the same content in a second medium, the second medium being different from the first medium; and
forward, in response to the selection of the selection of one of the first item and the second item, the selected one of the first item and the second item.

18. The storage device of claim 17, wherein:
the first item is a first advertisement;
the second item is a second advertisement that is different from the first advertisement;
the first medium is online; and
the second medium is print.

19. The storage device of claim 17, wherein the code segments, when executed, cause the at least one processor to identify the first item and the second item placed with the content in the first medium by determining that the first item and the second item are related to the content.

20. The storage device of claim 19, wherein the code segments, when executed, cause the at least one processor to determine that the first item and the second item are related to the content by:
determining a context of the content; and
determining that a context of the first item and a context of the second item are the same as the context of the content.
